(19) United States
(12) Patent Application Publication
(10) Pub. No.: US 2011/0139724 A1
(43) Pub. Date: Jun. 16, 2011

(54) Composition and Method for Reducing Chlorite in Water

(75) Inventor: Glenn W. Holden, Spring, TX (US)

(73) Assignee: Siemens Water Technologies Corp., Warrendale, PA (US)

(21) Appl. No.: 13/059,858

(22) PCT Filed: Aug. 28, 2009
(86) PCT No.: PCT/US09/55330

§ 371 Date: Feb. 18, 2011

Related U.S. Application Data
(60) Provisional application No. 61/093,034, filed on Aug. 29, 2008.

(51) Int. Cl. C02F 1/52; C02F 5/08; C02F 1/68

(52) U.S. Cl. 210/723; 252/175; 210/749

(57) ABSTRACT

A composition and method for reducing a concentration of chlorite in water. The composition comprises a mixture of ferrous iron and a polyaluminum chloride. The mixture is contacted with a water containing chlorite.

### CROSS-REFERENCE TO RELATED APPLICATIONS

This application claims the benefit of U.S. Provisional Application No. 61/093,034, filed Aug. 29, 2008, entitled COMPOSITION AND METHOD FOR REDUCING CHLORITE IN WATER, which is incorporated herein by reference for all purposes.

### BACKGROUND OF INVENTION

This invention relates generally to a method for treating water and, more particularly, for reducing a concentration of chlorite in water.

### SUMMARY OF INVENTION

One aspect of the invention is directed to a method for reducing a concentration of chlorite in water comprising providing water having a first chlorite concentration and providing a mixture comprising a ferrous iron and a polyaluminum chloride. A sufficient amount of the mixture is contacted with the water having a first chlorite concentration to produce a treated water having a second chlorite concentration less than the first concentration of chlorite. In one embodiment, the method may further include passing the treated water to a coagulation unit. In another embodiment, the method may further comprise providing water discharged from a coagulation unit. In other embodiments, the method further comprises contacting the water with from about 0.5 parts to about 6.5 parts ferrous iron per part of chlorite in the water.

In other embodiments, the mixture provided comprises at least one of ferrous chloride, ferrous sulfate, and ferrous citrate; and polyaluminum chloride. In yet another embodiment, the polyaluminum chloride in the mixture provided comprises a basicity ranging from about 50% to about 83%. In another embodiment, the mixture provided comprises at least one of Al₂(OH)₂Cl₄, Al₂(OH)₃Cl₃, and Al₂(OH)₅Cl.

In some embodiments the mixture provided is a solution of a water soluble ferrous iron complex and polyaluminum chloride. In another embodiment, the solution provided comprises ferrous iron ranging from about 0.5 mg to about 25 mg per liter of solution and the polyaluminum chloride ranging from about 5 mg to about 50 mg per liter of solution. In yet another embodiment, the mixture provided comprises a dry powder comprising ferrous iron and polyaluminum chloride.

Another aspect of the invention is directed to a composition for reducing chlorite in water comprising ferrous iron in a range of about 0.5 mg to about 25 mg per liter of the composition in solution and polyaluminum chloride in a range of about 5 mg to about 50 mg per liter of the composition in solution. In one embodiment the ferrous iron is at least one of ferrous chloride, ferrous sulfate, and ferrous citrate. In another embodiment, the polyaluminum chloride is at least one of Al₂(OH)₂Cl₄, Al₂(OH)₃Cl₃, and Al₂(OH)₅Cl.

Another aspect of the invention is directed to a method for reducing a concentration of chlorite in water. The method comprises providing water having a first chlorite concentration, providing a first solution comprising a ferrous iron, and providing a second solution comprising polyaluminum chloride. The method further comprises contacting a sufficient amount of the first solution and a sufficient amount of the second solution with the water having a first chlorite concentration to produce a treated water having a second chlorite concentration less than the first concentration of chlorite. In one embodiment, the step of contacting comprises contacting a sufficient amount of the first solution with the water prior to contacting a sufficient amount of the second solution with the water. In another embodiment, the step of contacting comprises contacting a sufficient amount of the second solution with the water prior to contacting a sufficient amount of the first solution with the water. In yet another embodiment, providing a first solution comprises providing at least one of ferrous chloride, ferrous sulfate, and ferrous citrate. In yet other embodiments, providing a second solution comprises providing at least one of Al₂(OH)₂Cl₄, Al₂(OH)₃Cl₃, and Al₂(OH)₅Cl.

Other advantages, novel features and objects of the invention will become apparent from the following detailed description of the invention.

### BRIEF DESCRIPTION OF DRAWINGS

In the drawings, each identical or nearly identical component that is illustrated in various figures is represented by a like numeral. For purposes of clarity, not every component may be labeled in every figure, nor is every component of each embodiment of the invention shown where illustration is not necessary to allow those of ordinary skill in the art to understand the invention. Preferred, non-limiting embodiments of the present invention will be described by way of example and with reference to the accompanying drawings, in which:

FIG. 1 is a block diagram illustrating a process in accordance with an embodiment of the invention;

FIG. 2 is a block diagram illustrating a process in accordance with another embodiment of the invention;

FIG. 3 is a block diagram illustrating a process in accordance with another embodiment of the invention;

FIG. 4 is a schematic diagram illustrating a computer system upon which one or more embodiments of the invention may be practiced; and

FIG. 5 is a schematic illustration of a storage system that may be used with the computer system of FIG. 3 in accordance with one or more embodiments of the invention.

### DETAILED DESCRIPTION

This invention is not limited in its application to the details of construction and the arrangement of components set forth in the following description or illustrated in the drawings. The invention is capable of other embodiments and of being practiced or of being carried out in various ways. Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

The present invention relates to the reduction of chlorite in water, which is a typical byproduct found in water treated with chlorine dioxide. As used herein “chlorite” and “chlorite ion” are used interchangeably to refer to ClO₂⁻. The term “water” is used herein to include any water containing chlorite to be treated, and includes, but is not limited to, industrial effluents, wastewater and potable water. Chlorine dioxide, a common disinfectant for water, often produces undesirable by-products, such as chlorite ions (ClO₂⁻). The presence of chlorite ions in discharge waters is typically regulated by national, state, and local governments. Intended use of water for particular applications may further limit the amount of chlorite present in water.

One method of removing chlorite includes adding ferrous iron to a flocculation tank, in which the chlorite ion is reduced to chloride and the ferrous iron forms a ferric hydroxide floc.

U.S. Pat. No. 7,384,565 discloses a method for chlorite removal in which a chlorite removal chemical selected from the group comprising sodium dichloroisocyanurate dihydrate, sodium dichloroisocyanurate, trichloroisocyanurate, polyaluminum chloride, sodium permanganate, potassium permanganate, and catalase enzyme is added to a body of water.

The presence of chlorite in water is often regulated due to its toxicity to several invertebrates which form the food chain. The United States Environmental Protection Agency has limited the amount of chlorite present in water treated for discharge to oceans, lakes, rivers and streams to less than or equal to about 0.12 ppm. In some localities the presence of chlorite in discharged water may be limited to less than or equal to about 0.006 ppm. The concentration of chlorite in drinking water is limited to 1.0 ppm, by the U.S. Environmental Protection Agency (40 CFR 141.64(a) July 2002), although lower concentrations of chlorite may be desired for water intended for use in a particular application. For example, because the presence of chlorite may be associated with a malodor under certain circumstances, many municipalities prefer a chlorite concentration in drinking water to be about zero. Similarly, water used for dialysis preferably has no, or no detectable, level of chlorite.

In many instances the dosage of chlorine dioxide used to treat a particular water may be ½ to 1 mg/L greater than demand. Many of the waters treated in North America are dosed with chlorine dioxide in a range from about 1 ppm to about 2 ppm. In some instances, it may be desirable to treat waters with even a larger dose to treat Cryptosporidium oocysts and Giardia cysts. However, the use of such high doses may result in a total chlorite formation that is above a desired and/or regulated concentration. Typically, between about 50% to 80% of the applied dosage of chlorine dioxide may be converted to chlorite. It is, therefore, common that for each 1 ppm of chlorine dioxide dosed to water, approximately from about 0.5 ppm to about 0.8 ppm chlorite ion may be formed.

In one embodiment of the present invention, a mixture of a ferrous iron and polyaluminum chloride may be contacted with a source of water to be treated having a first concentration of chlorite. The source of water may be a standing body of water subject to a holding time. Alternatively, the source of water may be a continuously flowing stream.

The reduction of chlorite by ferrous iron produces chloride, which is innocuous in water, according to the following equation.

4Fe²⁻+ClO₂⁻+10 H₂O< >4 Fe(OH)₃(s)+Cl⁻+8H⁺

Conventional use of ferrous iron alone to treat chlorite is typically considered to be too slow for industrial once-through water treatment systems. In particular, the by-product ferric hydroxide is slow to precipitate. In addition to the slow reaction time, the conventional use of ferrous iron alone also produces unacceptable levels of sludge.

The use of polyaluminum chloride alone to treat chlorite results in the formation of chlorides and chlorates without any appreciable production of sludge. However, the use of polyaluminum chloride alone to treat chlorite does not significantly reduce turbidity.

A mixture of ferrous iron and polyaluminum chloride to reduce a concentration of chlorite produces an unexpected synergistic effect, in that the mixture reduces the concentration of chlorite, reduces the turbidity of the water without the generation of significant amounts of sludge, and accelerates the removal of the byproduct ferric hydroxide. Polyaluminum chloride may also provide a catalytic effect in reducing chlorite ions to chloride and/or oxidizing the chlorite ions to chlorate.

The presence of the ferrous iron will produce some ferric oxides which will settle and thereby reduce the turbidity of water in addition to the effective reduction of chlorite water. The formation of the ferric oxides, such as ferric hydroxide further aids in the reduction of total organic carbons and trihalomethane/trihaloacetic acid organic precursors. The presence of the polyaluminum chloride results in the availability of aluminum salts which will coagulate and increase the precipitation rate of the byproduct ferric hydroxide.

It has been found that solutions containing sufficient ferrous iron for chlorite removal and sufficient polyaluminum chloride to reduce turbidity may exceed the solubilities of one or both resulting in precipitation of either or both ferrous iron and polyaluminum chloride. The use of a stable mixture of the ferrous iron and polyaluminum chloride which does not exceed blended solution solubility to reduce chlorite concentration in water will also result in an ease of use, in that one product may be used instead of two, thereby eliminating equipment and handling costs.

Any ferrous iron salt may be used in the present invention. In one embodiment, the ferrous iron may be in a water soluble complex. The water soluble complex may be in either an acidic or an alkaline water soluble form. In one embodiment, the ferrous iron may be in the soluble form of any of ferrous chloride, ferrous sulfate, ferrous citrate, ferrous acetate, ferrous lactate, and combinations thereof. In another embodiment, the ferrous iron may be in the soluble form of any of ferrous chloride, ferrous sulfate, ferrous citrate, and combinations thereof. The amount of ferrous iron present in the mixture may range from about 0.5 mg to about 25.0 mg per liter of the mixture in solution, which is sufficient to convert, for example by reducing to chloride, from about 0.5 ppm to about 10 ppm chlorite ion in the water to be treated.

As used herein, the term polyaluminum chloride is defined as a class of soluble aluminum products in which aluminum chloride has been partially neutralized with a base and in the water treatment industry is synonymous with aluminum chlorohydrate, ACH, PAC, polyaluminum hydroxychloride, among others. According to the present invention, polyaluminum chloride includes aluminum chlorohydrate, which is a group of salts having the general formula Alₙ(OH)ₘCl₍₃ₙ₋ₘ₎, where n may range from 1 to 50, and m may range from 1 to 150. The amount of polyaluminum chloride present in the mixture may range from about 5 mg to about 50 mg per liter of the mixture in solution to convert from about 0.5 ppm to about 10 ppm of chlorite in the water to be treated and to coagulate thereby precipitating any ferric hydroxide produced.

The polyaluminum chloride may be in any form, dry or in solution, having a basicity of about 10 percent to about 83 percent. Basicity is a factor in determining the molecular species distribution, in which a low basicity favors low molecular weight species, and high basicity favors a high molecular weight species. The basicity of any polyaluminum chloride is defined as the number of OH groups divided by the total number of OH groups and chloride ions multiplied by 100. Higher molecular weight species comprise a higher cationic charge and generally increased performance capabilities as compared to the low molecular weight species. In another embodiment, the polyaluminum chloride may have a basicity of about 30 percent to about 83 percent. In yet another embodiment, the polyaluminum chloride may have a basicity of about 50 percent to about 83 percent.

In one embodiment, the polyaluminum chloride may have the formula Al₂(OH)ₘCl₍₆₋ₘ₎, where m may range from 1 to 5. For example, in one embodiment, the polyaluminum chloride may be Al₂(OH)₂Cl₄, which has a basicity of about 33 percent. In another embodiment, the polyaluminum chloride may be Al₂(OH)₃Cl₃, which has a basicity of about 50 percent. In yet another embodiment, the polyaluminum chloride may be Al₂(OH)₅Cl, which has a basicity of about 83 percent.

Commercial polyaluminum chlorides are typically offered as solids or in solutions. It is understood that commercial grades of polyaluminum chloride may comprise many different molecular sizes and configurations in a single mixture in addition to the polyaluminum chloride having the formula Al₂(OH)ₘCl₍₆₋ₙ₎. For example, commercially available polyaluminum chloride may also include monomers such as be Al(OH)₂Cl, small polymers, ring structures, and unique polymers, the amount of which may affect the basicity of the polyaluminum chloride. Examples of small polymers include Al₂(OH)₂Cl₄ and Al₃(OH)₈Cl₁₀. Examples of ring structures include Al₆(OH)₁₂(H₂O)₁₂Cl₆.

In another embodiment, the polyaluminum chloride may comprise the cluster cation (Al₁₃O₄(OH)₂₄(H₂O)₁₂)⁷⁺. Al₁₂(OH)₂₄Cl₁₂ which is known to be based on Al₁₃ units with a Keggin ion structure and may act as a catalyst in oxidation-reduction reactions. The Keggin ion base structure may undergo complex transformations to form larger polyaluminum complexes. The cluster cation (Al₁₃O₄(OH)₂₄(H₂O)₁₂)⁷⁺ has a Keggin structure with a tetrahedral Al atom in the center of the cluster coordinated to 4 oxygen atoms which can be expressed as (AlO₄Al₁₂(OH)₂₄(H₂O)₁₂)⁷⁺ generally referred to as Al₁₃. The stability of this Keggin structure allows metals in the anion to be readily reduced or catalytically reactive. Depending on the acidity or basicity of the solution and the charge on the α-Keggin anion, the metal may be reversibly reduced in a one electron step or a multiple electron step. Chlorite may be reduced to chlorite or oxidized to chlorate via the Keggin structure arising from the tetrahedral Al ion in the center of the Keggin structure coordinated to four oxygen atoms. The Al anion in the center of the Keggin structure may also exchange with other metal ions in water solution that provides additional catalytic effects for reducing or oxidizing chlorite ions.

Ferrous iron and the polyaluminum chloride may be dry or wet mixed according to know mixing methods. In one embodiment, a solubilized ferrous iron is mixed with a solution of polyaluminum chloride, which may be stored for future use. In another embodiment, a solubilized ferrous iron and the solution of polyaluminum chloride may be combined at or just prior to a point of use. For example, the solubilized ferrous iron and the solution of the polyaluminum chloride may be individually directed to an inlet, or to an in-line mixer fluidly connected to an inlet, to the water to be treated thereby being mixed in real time on an as needed basis. In certain embodiments, an aqueous ferrous iron solution and a polyaluminum chloride solution may be added separately to the water to be treated. The solutions may be added sequentially to the water to be treated wherein the ferrous ion solution is added either before or after the polyaluminum chloride solution. In other embodiments, a dry powder or dry granular product comprising polyaluminum chloride and ferrous iron may be added directly to the water to be treated, or be used to prepare an aqueous solution that can subsequently be added to the water to be treated.

In one embodiment, the mixture of ferrous iron and polyaluminum chloride may be contacted with water having a first concentration of chlorite, in an amount sufficient to reduce the first concentration of chlorite to a desired concentration or a second concentration of chlorite lower than the first concentration. In one embodiment, the mixture may be added and subsequently mixed with the water to produce a treated water having a reduced concentration of chlorite. In another embodiment, the mixture may be added and simultaneously mixed with the water to produce a treated water having a reduced concentration of chlorite. The mixture may be added in-line, via a flash mixer or a flash mixer with a settler. In one embodiment, the concentration of chlorite may be reduced by a range of about 0.1 to about 6 ppm chlorite ion.

The mixture of ferrous iron and polyaluminum chloride may be manually or automatically added to the water to be treated, and contacted with the water to be treated for any amount of time to produce a desired reduction in the chlorite concentration. In one embodiment, the contact time of the mixture with the water ranges from about 5 seconds to about 30 minutes. Without being bound by any particular theory, it is believed the mixture of ferrous iron and polyaluminum chloride may be a blend in which both components retain their original chemical compositions. As noted, this mixture may provide a synergy in chlorite reduction by adding both ferrous iron and polyaluminum chloride simultaneously by augmenting the removal of reaction byproducts, such as ferric hydroxide. The addition of the mixture also increases the ease of using one product instead of adding each separately.

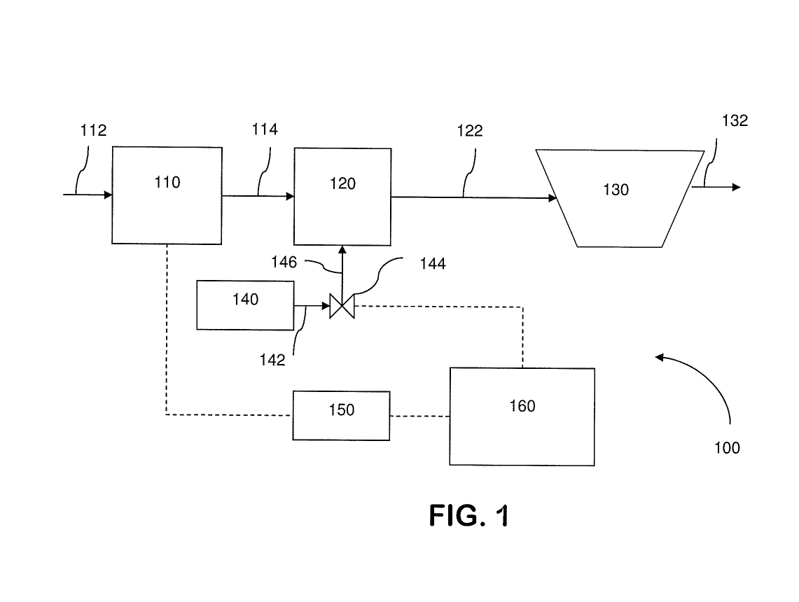

Referring to the figures, FIG. 1 illustrates one embodiment of the present water treatment system. The water treatment system 100 includes a source of water to be treated 110, having a first chlorite concentration greater than a desired chlorite concentration. The source of water 110 may be received via water delivery line 112 from any of an industrial effluent, wastewater, or potable water. In one embodiment, the water source 110 is potable water previously disinfected with chlorine dioxide. The source of water 110 may be temporarily held in a holding tank or delivered directly to process line 114 for further treatment in mixer 120.

A source of a mixture of ferrous iron and polyaluminum chloride 140 is fluidly connected to a mixer 120 via lines 142 and 146 though dispensing valve 144. Alternatively, dispensing valve may be fluidly connected to process line 114 upstream of mixer 120. Mixer 120 may be any mixer suitable for adequately combining the water containing chlorite and the mixture of ferrous iron and polyaluminum chloride. In, one embodiment, the mixer is an in-line mixer. In another embodiment, the mixer is a flash mixer. In yet another embodiment, the mixer is a combined flash mixer and settler.

Dispensing valve 144 may be any valve suitable for delivering a desired amount of the mixture of ferrous iron and aluminum chloride and may be manually or automatically controlled. In one embodiment, the valve 144 may automatically respond to a signal originating from a sensor 150 which may detect the concentration of chlorite in the source of water 110. Valve 144 may be a check valve, a gate valve, a diaphragm valve, a globe valve, a butterfly valve, or the like. In response to a signal generated by sensor 150, the valve may respond by fully opening and closing in some embodiments, or by partially opening and closing in other embodiments.

Chlorite sensor 150 may be any sensor capable of detecting a concentration of chlorite in water. In one embodiment, the chlorite sensor 150 may be capable of detecting a chlorite concentration in water of about 1 ppm. In another embodiment, the chlorite sensor may be capable of detecting a chlorite concentration in water of about 0.1 ppm. The sensor may be located in any one or more appropriate positions for a particular purpose, such as, upstream of the mixer 120 to provide a feed forward configuration. In one embodiment, the sensor may be located in mixer 120. In another embodiment, the sensor 150 may be located downstream of mixer 120 to provide a feedback configuration in addition to, or place of, an upstream sensor.

Controller 160 may respond to a signal generated by chlorite sensor 150. In addition to, or alternatively, controller 160 may respond to other sensors, not shown, which detect one or more operational parameters such as pH of the water to be treated and/or flow rates of the water to be treated. Controller 150 may respond by generating a control signal causing dispensing valve 144 to open or close, either partially or completely, thereby increasing, decreasing, or completely interrupting the flow of the mixture of ferrous iron and polyaluminum chloride to mixer 120.

As shown in FIG. 1, treated water having a second concentration of chlorite less than the first concentration may exit mixer 120 via line 122 and may then be passed to coagulator 130. As used herein, the term “coagulator” includes conventional coagulating and flocculation units. Coagulator unit 130 may be sized and shaped to receive a desired amount of treated water. The coagulator unit may be any unit typically used in the water treatment industry. One or more coagulation and/or flocculation agents (not shown) may be added to the coagulator. Examples of known coagulation agents include: alum; acid alum; polyaluminum chloride; aluminum chlorohydrate and combinations thereof. Other examples of known coagulation agents include any of alum, acid alum polyaluminum chloride, aluminum chlorohydrate combined with any of diallyldimethyl-ammonium chloride (DADMAC) polymer, a polyamine polymer or an epichlorohydrin based polymer. Effluent from the coagulator 130 may then be discharged to the environment or discharged to a potable water distribution system. Alternatively, effluent from coagulator 130 may be directed to additional treatment units, such as a cooling tower.

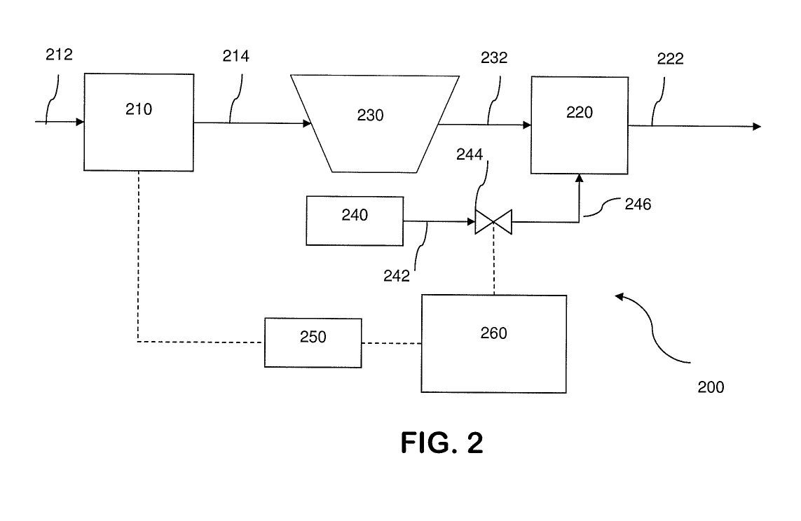

Referencing FIG. 2, water treatment system 200 is similar to water treatment system 100, with the exception that mixer 220 receives effluent from coagulator 230 instead of directly from the source of water containing chlorite 210. Identical components in FIG. 1 and FIG. 2 have corresponding reference numerals. For example, the source of water 110 in FIG. 1 is identical to the source of water 210 in FIG. 2, the mixer 120 in FIG. 1 is identical to the mixer 220 in FIG. 2, and so on.

In the embodiment shown in FIG. 2, the source of water 210 containing a first concentration of chlorite is first treated in coagulator 230. The effluent from coagulator 230 may then be passed to mixer 220 where it is contacted with the mixture of ferrous iron and polyaluminum chloride to reduce the chlorite concentration to a desired level. The sensor 250 may be located in any one or more appropriate positions for a particular purpose, such as, upstream of the mixer 220 in a feed forward configuration. For example, the sensor 250 may be positioned in any one of the source of water 210, the coagulator 230, and the coagulator effluent line 232. In one embodiment, the sensor may be located in mixer 220. In another embodiment, the sensor 250 may be located downstream of mixer 220 providing a feedback configuration in addition to, or in place of, an upstream sensor.

Controller 260 may respond to a signal generated by chlorite sensor 250. In addition to, or alternatively, controller 260 may respond to other sensors, not shown, which detect one or more operational parameters such as pH of the water to be treated and/or flow rates of the water to be treated. Controller 250 may respond by generating a control signal causing dispensing valve 244 to open or close, either partially or completely, thereby increasing, decreasing, or completely interrupting the flow of the mixture of ferrous iron and polyaluminum chloride to mixer 220.

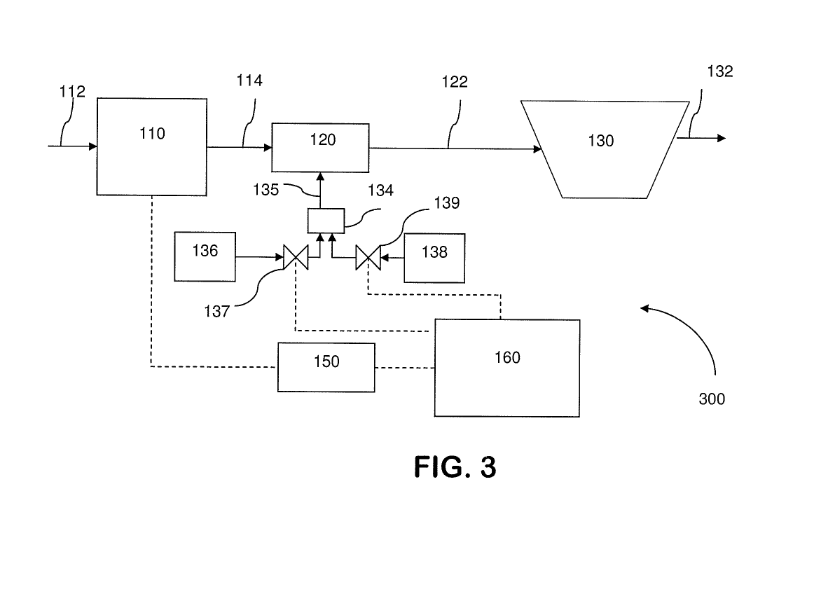

FIG. 3 shows another embodiment of the system of FIG. 1, in which the source of a mixture of ferrous iron and polyaluminum chloride 140 is replaced by a source of solubilized ferrous iron 136 and a source of a solution of polyaluminum chloride 138. In FIG. 3, the source of ferrous iron 136 is fluidly connected to mixer 134 via dispensing valve 137, and the source of polyaluminum chloride 138 is fluidly connected to mixer 134 via dispensing valve 137. Dispensing valves 136 and 138 may be any valve suitable for delivering a desired amount of the mixture of ferrous iron and aluminum chloride and may be manually or automatically controlled. In one embodiment, the valves 136, 138 may automatically respond to a signal originating from a sensor 150 which may detect the concentration of chlorite in the source of water 110. Valves 136, 148 may be a check valve, a gate valve, a diaphragm valve, a globe valve, a butterfly valve, or the like. In response to one or more signals generated by sensor 150, one or both valves 137, 139 may respond by fully opening and closing in some embodiments, or by partially opening and closing in other embodiments.

Mixer 134 may be any mixer suitable for adequately mixing the ferrous iron and the polyaluminum chloride. In one embodiment, the mixer is an in-line mixer. In yet another embodiment, the mixer is a combined flash mixer and settler. The mixture of ferrous iron and polyaluminum chloride may exit mixer 134 and enter mixer 120 via line 135. In another embodiment, line 135 may direct the mixture of ferrous iron and polyaluminum chloride to line 114 upstream of mixer 120. In another embodiment, not shown, mixer 134 may be omitted so that each of the source of ferrous iron 136 and the source of polyaluminum chloride 138 may be individually directed to mixer 120 or to line 114 upstream of mixer 120, by their respective valves 137, 139 without premixing of the ferrous iron and polyaluminum chloride.

Controller 160 may respond to a signal generated by chlorite sensor 150. In addition to, or alternatively, controller 160 may respond to other sensors, not shown, which detect one or more operational parameters such as pH of the water to be treated and/or flow rates of the water to be treated. Controller 150 may respond by generating a control signal causing one or both dispensing valves 136, 138 to open or close, either partially or completely, thereby increasing, decreasing, or completely interrupting the individual flow of the ferrous iron and/or polyaluminum chloride to mixer 134.

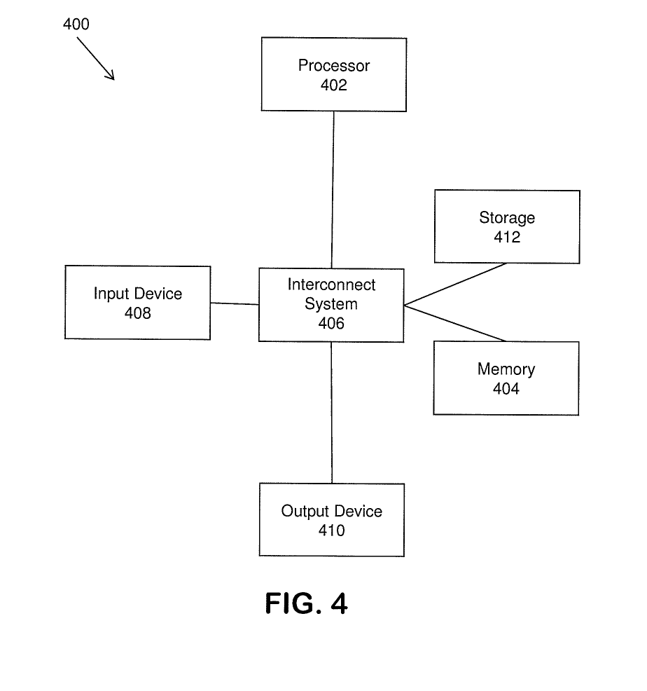

The controller 160, 260 of the system of the invention may be implemented using one or more computer systems 400 as exemplarily shown in FIG. 4. Computer system 400 may be, for example, a general-purpose computer such as those based on in Intel PENTIUM®-type processor, a Motorol PowerPC® processor, a Hewlett-Packard PA-RISC® processor, a Sun UltraAPARC® processor, or any other type of processor or combination thereof. Alternatively, the computer system may include specially-programmed, special-purpose hardware, for example, an application-specific integrated circuit (ASIC) or controllers intended for water treatment systems.

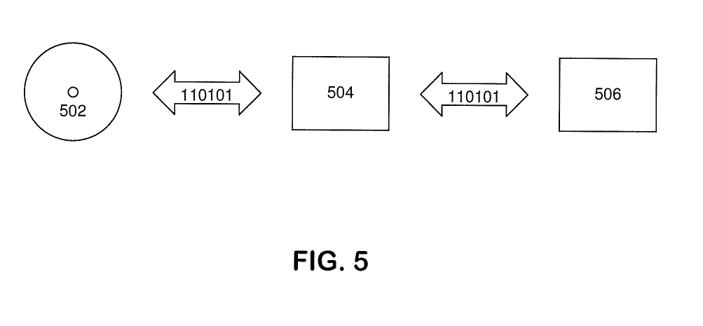

Referring to FIG. 4, computer system 400 can include one or more processors 402 typically connected to one or more memory devices 404, which can comprise, for example, any one or more of a disk drive memory, a flash memory device, a RAM memory device, or other device for storing data. Memory 404 is typically used for storing programs and data during operation of the system 100, 200, 300 and/or computer system 400. For example, memory 404 may be used for storing historical data relating to the parameters over a period of time, as well as operating data. Software, including programming code that implements embodiments of the invention, can be stored on a computer readable and/or writeable nonvolatile recording medium (discussed further with respect to FIG. 5), and then typically copied into memory 404 wherein it can then be executed by processor 402. Such programming code may be written in any of a plurality of programming languages, for example, Java, Visual Basic, C, C#, or C++, Fortran, Pascal, Eiffel, Basic, COBAL, or any of a variety of combinations thereof.

Components of computer system 400 may be coupled by one or more interconnection mechanisms 406, which may include one or more busses (e.g., between components that are integrated within a same device) and/or a network (e.g., between components that reside on separate discrete devices). The interconnection mechanism typically enables communications (e.g., data, instructions) to be exchanged between components of system 400.

Computer system 400 can also include one or more input devices 408, for example, a keyboard, mouse, trackball, microphone, touch screen, and other man-machine interface devices as well as one or more output devices 410, for example, a printing device, display screen, or speaker. In addition, computer system 400 may contain one or more interfaces (not shown) that can connect computer system 400 to a communication network (in addition or as an alternative to the network that may be formed by one or more of the components of system 400).

According to one or more embodiments of the invention, the one or more input devices 408 may include sensors for measuring parameters of system 100, 200, 300 and/or components thereof. Alternatively, the sensors, the metering valves and/or pumps, or all of these components may be connected to a communication network (not shown) that is operatively coupled to computer system 400. Any one or more of the above may be coupled to another computer system or component to communicate with computer system 400 over one or more communication networks. Such a configuration permits any sensor or signal-generating device to be located at a significant distance from the computer system and/or allow any sensor to be located at a significant distance from any subsystem and/or the controller, while still providing data therebetween. Such communication mechanisms may be affected by utilizing any suitable technique including but not limited to those utilizing wireless protocols.

As exemplarily shown in FIG. 5, controller 400 can include one or more computer storage media such as readable and/or writeable nonvolatile recording medium 502 in which signals can be stored that define a program to be executed by one or more processors 402. Medium 502 may, for example, be a disk or flash memory. In typical operation, processor 402 can cause data, such as code that implements one or more embodiments of the invention, to be read from storage medium 502 into a memory 504 that allows for faster access to the information by the one or more processors than does medium 502. Memory 504 is typically a volatile, random access memory such as a dynamic random access memory (DRAM) or static memory (SRAM) or other suitable devices that facilitates information transfer to and from processor 402.

Although computer system 400 is shown by way of example as one type of computer system upon which various aspects of the invention may be practiced, it should be appreciated that the invention is not limited to being implemented in software, or on the computer system as exemplarily shown. Indeed, rather than implemented on, for example, a general purpose computer system, the controller, or components or subsections thereof, may alternatively be implemented as a dedicated system or as a dedicated programmable logic controller (PLC) or in a distributed control system. Further, it should be appreciated that one or more features or aspects of x\the invention may be implemented in software, hardware or firmware, or any combination thereof. For example, one or more segments of an algorithm executable by controller 160, 260 can be performed in separate computers, which in turn, can be communication through one or more networks.

### EXAMPLES

### Removal of Chlorite Ion from Drinking Water

Testing was performed on water samples containing chlorite to compare the extent of chlorite reduction in water using ferrous chloride only versus using a pre-mixed blend of ferrous chloride and polyaluminum chloride. The concentration of chlorite was measured prior to the addition of either ferrous chloride only or a ferrous chloride/polyaluminum chloride blend, and then measured at 5 minutes, 15 minutes, and 30 minutes after the addition. The amount of chlorite in the water was measured using amperometric titration per the Environmental Protection Agency (EPA) Standard Method.

### Example 1

### Dosing of Ferrous Chloride (FeCl₂.4H₂0) only

Testing was performed to obtain a baseline for reduction of chlorite in water by treatment with ferrous chloride only. Potable water samples, at neutral pH, were dosed with approximately 1 ppm and 2.5 ppm of chlorite ion. The analysis before chlorite reduction treatment using amperometric titration per the EPA Standard Method showed a free residual of 1.32 ppm and 2.5 ppm of ClO₂ (chlorite ion) respectively, as shown in Table 1.

TABLE 1

| | | | | Residual | Residual | Residual |
|---|---|---|---|---|---|---|
| Chlorite | | Fe | | ClO₂⁻ | ClO₂⁻ | ClO₂⁻ |
| dosage | Sample | dosage | Ratio | 5 min | 15 min | 30 min |
| (ppm) | Number | (ppm) | Fe⁺²/ClO₂⁻ | (mg/L) | (mg/L) | (mg/L) |
| 1.32 | 1 | 4.5 | 3.4 | 0.67 | 0.31 | 0.30 |
| 1.32 | 2 | 5.3 | 4.0 | 0.44 | 0.22 | 0.19 |
| 1.32 | 3 | 6.6 | 5.0 | 0.37 | 0.11 | <0.1 |
| 2.5 | 4 | 8.3 | 3.3 | 0.53 | 0.28 | 0.28 |
| 2.5 | 5 | 10 | 4.0 | 0.48 | 0.30 | 0.21 |
| 2.5 | 6 | 12.5 | 5.0 | 0.53 | 0.29 | <0.1 |

Testing of the chlorite concentration in water was performed at 5 minutes, 15 minutes, and 30 minutes. As shown in Table 1, each water sample containing chlorite, at a concentration of either 1.32 ppm or 2.5 ppm demonstrated a reduction of chlorite concentration after addition of the ferrous chloride over the time interval. However, some samples demonstrated a more effective reduction in chlorite, depending on the calculated ratio of ferrous ion to chlorite. The results indicate that ferrous chloride effectively oxidizes the chlorite ion to a concentration of less than 0.1 ppm in the water at a ratio of about 5 to 1 ferrous ion to chlorite in 30 minutes. This reduction in chlorite concentration was independent of the starting concentration of chlorite. That is, a reduction in chlorite concentration to less than 0.1 ppm was evidenced in the water sample having an initial chlorite concentration of 1.32 ppm (Sample 3) and 2.5 ppm (Sample 6), wherein the ratio of ferrous ion to chlorite was 5.0 to 1. In all other samples, where the ratio of ferrous ion to chlorite was 4.0 to 1 or less, although a reduction in the chlorite concentration was observed, there was still a significant concentration of chlorite left in the water, even 30 minutes after the addition of ferrous chloride. These results are in line with previous findings, which suggest that conventional use of ferrous iron alone to treat chlorite is typically considered to be too slow for industrial once-through water treatment systems.

### Example 2

### Dosing a Pre-Mixed Blend of Polyaluminum Chloride (PAC) and Ferrous Chloride

Testing was performed to compare the reduction in chlorite in water by treatment with a pre-mixed blend of polyaluminum chloride and ferrous chloride to the baseline results obtained in Example 1 using ferrous chloride only. A PAC solution was prepared having 70% basicity and 26% aluminum oxide (Al₂O₃). Sufficient ferrous chloride was added to the PAC solution to produce a blend that allowed a dosage of 0.5 mg/l of Fe⁺² per 5 mg/l of PAC (neat).

As in Example 1, potable water samples, at neutral pH, were dosed with approximately 1 ppm, 2.5 ppm, and 4.0 ppm of chlorite ion. The analysis before chlorite reduction treatment using amperometric titration per the EPA Standard Method showed a free residual of 1.32 ppm, 2.5 ppm, and 4.3 ppm of chlorite, respectively, as shown in Table 2.

TABLE 2

| | | | | | Residual | Residual | Residual |
|---|---|---|---|---|---|---|---|
| Chlorite | | | | Ratio | ClO₂⁻ | ClO₂⁻ | ClO₂⁻ |
| dosage | Sample | Fe⁺² | PAC | Fe⁺²/ClO₂⁻ | 5 min. | 15 min. | 30 min |
| (ppm) | Number | dosage | dosage | (mg/L) | (mg/L) | (mg/L) | (mg/L) |
| 1.32 | 7 | 4.5 | 22.5 | 3.4 | 0.53 | 0.21 | <0.1 |
| 1.32 | 8 | 5.3 | 26.5 | 4.0 | 0.20 | 0.12 | <0.1 |
| 1.32 | 9 | 6.6 | 33 | 5.0 | 0.17 | <0.1 | <0.1 |
| 2.5 | 10 | 8.3 | 41.5 | 3.4 | 0.46 | 0.27 | <0.1 |
| 2.5 | 11 | 10 | 50 | 4.0 | 0.31 | 0.16 | <0.1 |
| 2.5 | 12 | 12.5 | 62.5 | 5.0 | 0.30 | <0.1 | <0.1 |
| 4.3 | 13 | 14.2 | 71 | 3.3 | 0.14 | <0.1 | <0.1 |
| 4.3 | 14 | 17.2 | 86 | 4.0 | 0.11 | <0.1 | <0.1 |
| 4.3 | 15 | 21.5 | 107.5 | 5.0 | <0.1 | <0.1 | <0.1 |

Testing of the chlorite concentration in water was performed at 5 minutes, 15 minutes, and 30 minutes. As shown in Table 2, each water sample having an initial chlorite concentration of 1.32 ppm, 2.5 ppm, and 4.3 ppm demonstrated a reduction of chlorite concentration after addition of the pre-mixed blend over the time interval. However, some samples demonstrated a more effective reduction in chlorite, depending on the calculated ratio of ferrous ion to chlorite, and the initial concentration of chlorite in the water. For example, after 5 minutes, Sample 15, having an initial chlorite concentration of 4.3 ppm and a ferrous ion to chlorite ratio of 5.0 to 1 demonstrated a reduction in chlorite concentration to less than 0.1 after only 5 minutes. After 15 minutes, all samples having a ferrous ion to chlorite ratio of 5.0 to 1 (Samples 9, 12, and 15) demonstrate a reduction in chlorite concentration to less than 0.1 ppm, independent of the initial chlorite concentration in the sample. Additional samples having a ferrous ion to chlorite ratio of 3.3 to 1 and 4.0 to 1 (Samples 13 and 14) also demonstrate a reduction in chlorite concentration to less than 0.1 ppm after 15 minutes, having an initial chlorite concentration of 4.3 ppm. After 30 minutes, all samples, independent of ratio or initial chlorite concentration achieved a reduction in chlorite concentration of less than 0.1 ppm.

These results demonstrate that there is a significant improvement in chlorite removal when ferrous iron is added concurrently with polyaluminum chloride. When the ratio of ferrous ion to chlorite is 5.0 to 1, and in certain cases where the ratio is 3.3 or 4.0 to 1, the concentration of chlorite is reduced to less than 0.1 ppm in 15 minutes. The rate of chlorite reduction using the pre-mixed blend of PAC and ferrous ion is higher than dosing with ferrous chloride only, wherein only some of the samples using ferrous chloride had a reduction of chlorite to less than 0.1 ppm after 30 minutes. By 30 minutes, treating the water with the pre-mixed blend resulted in all samples having a reduction of chlorite to less than 0.1 ppm, while very few samples achieved this reduction when treating with only ferrous chloride. These unexpected results demonstrate the synergistic effect of using ferrous iron in combination with polyaluminum chlorite to treat water containing chlorite.

Similar removal efficiencies and rate of removal are obtained as in Table 2 above, when sequentially feeding aqueous ferrous iron solution and 50% to 70% basicity PAC solutions to the water containing chlorite ion. Results did not change depending on whether the ferrous iron solution was added before or after the PAC solution.

In summary, chlorite removal efficiency and rate of chlorite removal is significantly improved by dosing a pre-blend of ferrous iron with PAC, or by the sequential dosing of each active agent to the water to be treated, allowing for synergistic and enhanced removal of chlorite ion.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A method for reducing a concentration of chlorite in water comprising:
providing water having a first chlorite concentration;
providing a mixture comprising a ferrous iron and a polyaluminum chloride; and
contacting a sufficient amount of the mixture with the water having a first chlorite concentration to produce a treated water having a second chlorite concentration less than the first concentration of chlorite.

2. The method of claim 1, further comprising passing the treated water to a coagulation unit.

3. The method of claim 1, wherein providing water comprises providing water discharged from a coagulation unit.

4. The method of claim 1, wherein providing the mixture comprises providing a solution of a water soluble ferrous iron complex and polyaluminum chloride.

5. The method of claim 1, wherein providing the mixture comprises providing a dry powder comprising ferrous iron and polyaluminum chloride.

6. The method of claim 1, wherein providing the mixture comprises providing a mixture of at least one of ferrous chloride, ferrous sulfate, and ferrous citrate and polyaluminum chloride.

7. The method of claim 6, wherein providing the mixture comprises providing a mixture comprising ferrous iron complex and polyaluminum chloride, wherein the polyaluminum chloride has a basicity ranging from about 50% to about 83%.

8. The method of claim 4, wherein providing the mixture comprises providing a mixture of ferrous iron complex and at least one of Al₂(OH)₂Cl₄, Al₂(OH)₃Cl₃, and Al₂(OH)₅Cl.

9. The method of claim 1, wherein contacting a sufficient amount of the mixture with the water having a first chlorite concentration comprises contacting the water with from about 0.5 parts to about 6.5 parts ferrous iron per part of chlorite in the water.

10. The method of claim 4, wherein providing a solution comprises providing a solution comprising the ferrous iron ranging from about 0.5 mg to about 25 mg per liter of solution and the polyaluminum chloride ranging from about 5 mg to about 50 mg per liter of solution.

11. A composition for reducing chlorite in water comprising:
ferrous iron in a range of about 0.5 mg to about 25 mg per liter of the composition in solution; and
polyaluminum chloride in a range of about 5 mg to about 50 mg per liter of the composition in solution.

12. The composition of claim 11, wherein the ferrous iron is at least one of ferrous chloride, ferrous sulfate, and ferrous citrate.

13. The composition of claim 12, wherein the polyaluminum chloride is at least one of Al₂(OH)₂Cl₄, Al₂(OH)₃Cl₃, and Al₂(OH)₅Cl.

14. A method for reducing a concentration of chlorite in water comprising:
providing water having a first chlorite concentration;
providing a first solution comprising a ferrous iron;
providing a second solution comprising polyaluminum chloride; and
contacting a sufficient amount of the first solution and a sufficient amount of the second solution with the water having a first chlorite concentration to produce a treated water having a second chlorite concentration less than the first concentration of chlorite.

15. The method of claim 14, wherein contacting comprises contacting a sufficient amount of the first solution with the water prior to contacting a sufficient amount of the second solution with the water.

16. The method of claim 14, wherein contacting comprises contacting a sufficient amount of the second solution with the water prior to contacting a sufficient amount of the first solution with the water.

17. The method of claim 14, wherein providing a first solution comprises providing at least one of ferrous chloride, ferrous sulfate, and ferrous citrate.

18. The method of claim 14, wherein providing a second solution comprises providing at least one of Al₂(OH)₂Cl₄, Al₂(OH)₃Cl₃, and Al₂(OH)₅Cl.
